(19) United States
(12) Patent Application Publication
(10) Pub. No.: US 2007/0221652 A1
(43) Pub. Date: Sep. 27, 2007

(54) Heating appliance

(76) Inventor: Ting Fun Cheng, Hong Kong (HK)

Correspondence Address: SAWYER LAW GROUP LLP, P O BOX 51418, PALO ALTO, CA, 94303, US

(21) Appl. No.: 11/370,964

(22) Filed: Mar. 7, 2006

(51) Int. Cl. H05B 3/68

(52) U.S. Cl. 219/448.11

(57) ABSTRACT

A space heat appliance 2 employs an electrical heating plate 4 incorporating a resistance type heating element, sandwiched between a pair of heat-distributing corrugated metal plates 6, 8 having vertically arranged corrugations, provided adjacent a stone slab 10 whereby heat from the heating plate 4 provides heating of the stone slab which in turn radiates the heat as a far infra-red heat.

### FIELD OF THE INVENTION

The present invention relates to a heating appliance and more particularly to a heating appliance which employs a stone element providing a radiative heating effect.

### BACKGROUND OF THE INVENTION

A variety of types of heating appliances have been utilized for space heating applications for many years, including wall-mounted radiators through which hot water is circulated, fan heaters, oil heaters.

In recent years it has become popular to employ heating appliances which include a stone or stone-like member, such having a relatively high mass and heat capacity, the stone member being heated by external means such as an electrical resistance type heater, the stone providing a heat storage effect. As the stone warms, it re-emits the heat as far infra-red type radiation. Such radiation is believed to provide various health enhancing effects on the human body, particularly for muscles and joints. Such heating appliances are particularly popular for use in health spas, and increasingly installed in domestic situations for example in a bathroom within the home.

The present invention is directed to an improved heating appliance of this type.

### SUMMARY OF THE INVENTION

According to a first aspect of the invention there is provided a heating appliance for providing space heating comprising an electrical heating plate, a first corrugated metal plate disposed adjacent the electrical heating plate with said corrugations arranged substantially vertically, and a stone member disposed adjacent said corrugated metal plate.

The stone member may be formed of natural marble, granite or limestone, or may be synthetic stone-like material.

The corrugated metal plate serves to distribute the heat from the heating plate evenly towards the stone member, whilst also providing a controlled convective effect.

Preferably an additional corrugated metal plate is provided, likewise with the corrugations vertically arranged in the installed orientation.

The electrical heating plate comprises an electrical resistance heating element supported on or forming part of a plate of heat resistant material, the plate being formed of material such as a mica.

In the preferred embodiment the first corrugated metal plate is of shorter dimension in the vertical direction than the stone member and is disposed towards an upper region of the stone member, whereby at a lower region the electrical heating plate directly faces the stone member. More preferably, the first corrugated metal plate extends about two-thirds of the way down the stone member whereby the stone member is directly exposed to the heating plate at the lower third thereof.

It may be arranged that the first metal plate or both metal plates are of a mesh-like structure.

In a further aspect the invention provides a heating appliance for space heating comprising an electrical heat supplying plate, a pair of corrugated metal plates including a front plate disposed respectively on a front face of the heating plate, and a rear plate disposed on a rear face, and a stone slab disposed adjacent the front corrugated metal plate, and a rear housing, with said corrugated metal plates and heating plate enclosed and supported between the rear cover and stone slab.

### BRIEF DESCRIPTION OF THE DRAWINGS

The present invention is now described, by way of example only, with reference to the following drawings in which:

FIG. 1 is a view of a heating appliance according to a first embodiment of the invention, viewed from above;

FIG. 2 is a side edge view of the heating appliance of FIG. 1;

FIG. 3 is an exploded view of the main components of the heating appliance of FIG. 1, viewed from the rear.

FIG. 4 shows a metal plate as disposed towards the front side of the heating appliance;

FIG. 5 shows a metal plate as disposed towards the rear side of the heating appliance;

FIG. 6 is an exploded view of a heating appliance according to a second embodiment of the invention; and

FIG. 7 is an exploded view of a heating appliance according to a third embodiment of the invention.

### DETAILED DESCRIPTION OF THE INVENTION

The present invention relates generally to a heating appliance and more particularly to a heating appliance which employs a stone element providing a radiative heating effect. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Turning to the drawings, the heating appliance according to a first embodiment of the invention is indicated generally by numeral 2. The major components of the heating appliance 2 comprise a heating plate 4 which is sandwiched between a pair of corrugated metal plates 6, 8 adjacent a stone or stone-like member 10 disposed to the forward face of the appliance. These components are secured to a rear cover 12 which with the stone member 10 encloses the heating plate 4 and metal plates 6 and 8.

The stone member 10 is composed of a planar member or slab of natural or synthetic type stone. A wide variety of stone compositions can be used provided they have sufficient density and strength, but typically natural marble, granite or limestone are used for their structural and decorative qualities and excellent radiative properties, whereby once heated they emit radiation at a “soft” far infra-red wavelength. Ceramic materials may also be used.

The heating plate 4 comprises an electrical resistance-type element sandwiched between or secured on a plate or plates of heat-resistant material such as a dielectric such as mica. Such plates are sometimes referred to as micathermic plates. The electrical resistance element is typically in the form of a wire or ribbon disposed in a serpentine pattern across the face of the heating plate to provide an even heating effect. A control unit (not shown) may be provided to allow control of the current supplied to the heating plate, and to provide other functions such as an on/off switch and timer.

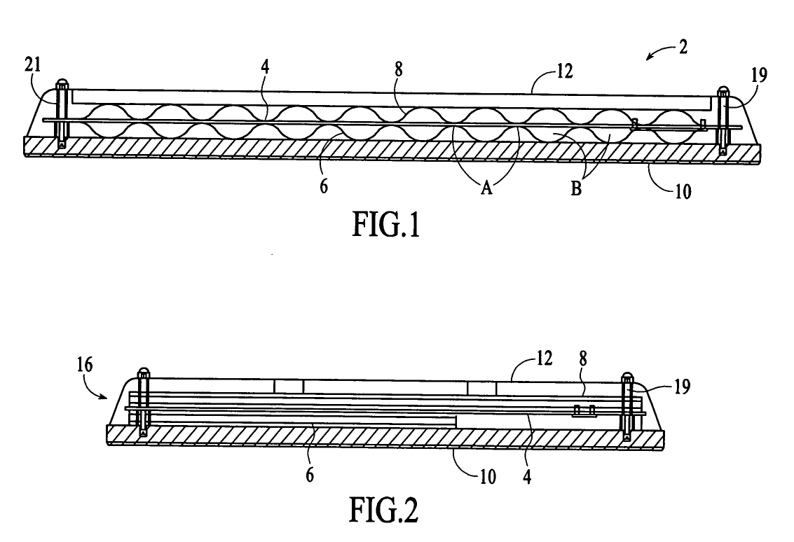

The heating plate 4 is sandwiched between a front metal plate 6 and rear metal plate 8 both of which are formed of a thin sheet of heat conductive metal, conveniently aluminium, pressed to a shape comprising a series of corrugations, which in the installed orientation of the appliance are arranged vertically. The metal plates 6 and 8 have flat edge regions 14, 16 at which they are fixed to the heating plate 4 using bolts 19, screws or other convenient fasteners. The metal plates 6 and 8 serve to control the distribution of heat from the heating plate 4, but also to provide a protective function for the relatively fragile heating plate 4. In those regions where the front metal plate 6 touches the heating plate 4, some of which are indicated A in FIG. 1, the heat will be conducted through the metal plate, and radiated outwardly in the forward direction heating the stone member 10. In the regions where the heating plate 4 is spaced from the metal plate 6, some of which are indicated B, heat will both radiate outwardly towards the corrugations of the metal plate from where it will re-radiate towards the stone member 10, but in addition will heat the air within the corrugations, whereby a significant convective heating effect occurs with warm air rising up within the corrugations and out at the top of the heating appliance 2 through openings 16 at the uppermost region of the cover 12. At the lower region of the cover further openings 18 (not visible) are formed for the inflow of cool air. At the rear plate 8 in a similar manner both a radiative and convective heat transfer arises. The radiation however is largely contained, with the assistance of a rear reflective metal plate 20 on the side of the cover 12 which serves to reflect heat back into the appliance. Although sinusoidal corrugations are illustrated it should be appreciated that a variety of other shapes might be utilized.

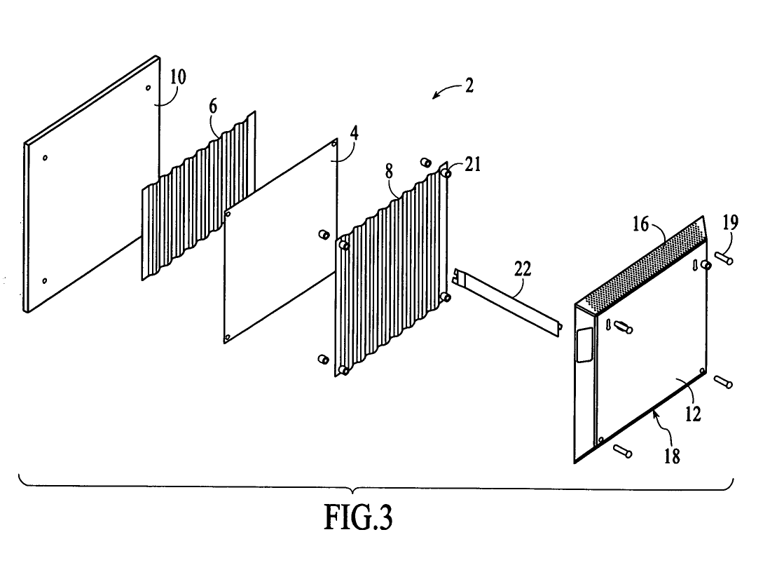

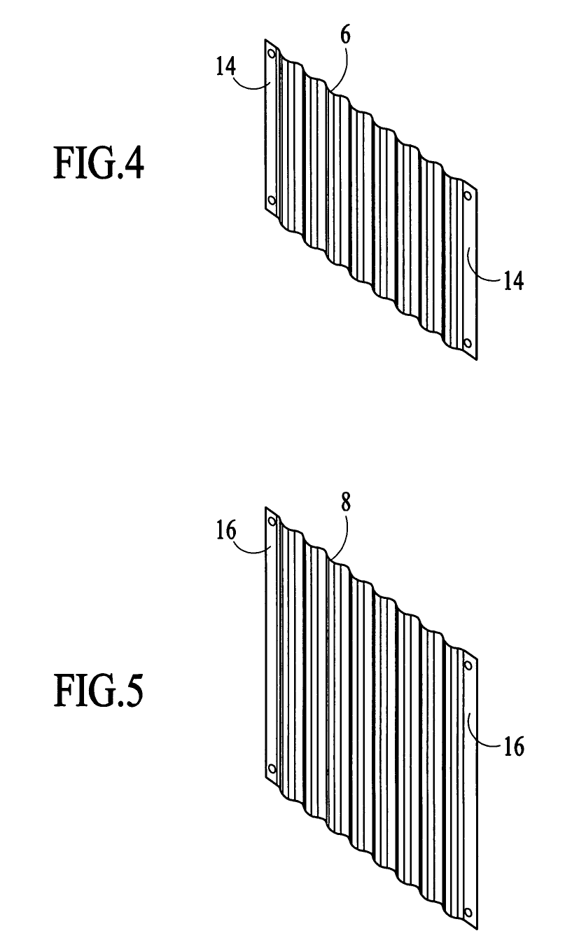

As can be seen in FIGS. 2, 3 and 4 the corrugated metal plate 6 to the fore is shorter in the vertical dimension, extending only about two-thirds of the way down the heating plate 4 in contrast to the rear corrugated metal plate 8 which has a dimension which is about the same as that of the heating plate 4 and stone slab 10. This reduced dimension further serves to equalize the heat distribution in that in the lower region where the corrugated metal plate is absent heat radiates directly from the heating plate 4 to the stone slab 10. If the plate 6 were of the same dimension as the rear plate 8 a significant temperature gradient would exist between the upper region of the stone member 10 and lower region. It is found that the relative dimension of about two-thirds of the height is appropriate to give a particularly evenly distributed heating effect. It is found that even a relatively small departure from this two-thirds dimension has a derogatory effect, for example at half height the upper region can become hotter than the upper region, whilst if the dimension is at three-quarters height the lower region becomes cooler than the upper. With an equalized temperature distribution the heater power can be increased without the risk of excessively hot spots on the stone member 10. It is found that a power of about 1100 w is readily achievable, whilst powers up to 1500 w are generally possible. Moreover, the long term effects of the heat on the stone member, which can degrade over time with increased heat, can be minimized.

The appliance components are secured together conveniently by uses of screws or bolts indicated 19 which extend from the rear cover through aligned openings in the rear cover 12, plate 8, heating plate 4, plate 6 and into openings or recesses in the stone member 10. Spacers 21 provide appropriate positioning of the plates. Slots or other appropriate means on the rear cover 12 may be provided to facilitate the mounting of the appliance 2 onto a wall or other surface.

A thin metallic strip 22 may also be provided extending diagonally across the plate 8 between opposite corners for the purpose of increasing the rigidity of the plate 8.

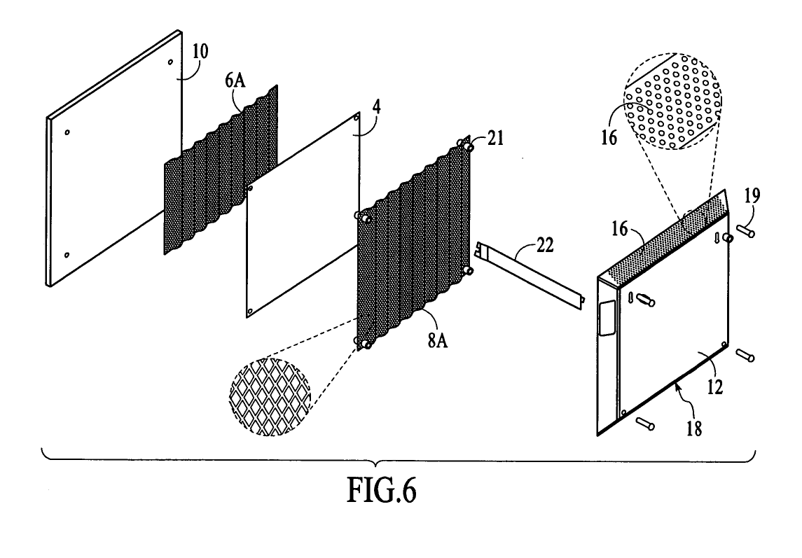

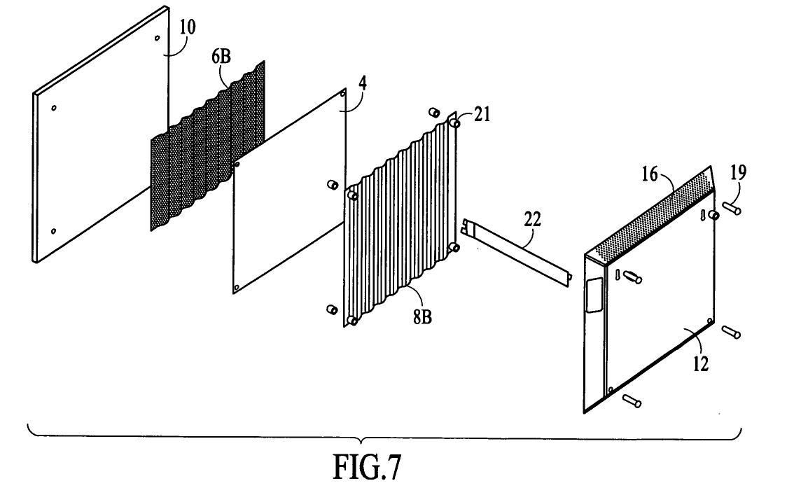

A second embodiment of the invention is illustrated in FIG. 6, which is an exploded perspective view from slightly to the rear. This second embodiment has a similar overall construction to the first embodiment, and like reference numbers are used to indicate like parts, but differs in particular in relation to the construction of the corrugated metal plates. Instead of being formed of solid continuous pressed metal sheets, the plates, indicated 6A and 8A, which are still of corrugated form, have a mesh-like structure presenting a large number of openings therethrough. By providing such a mesh-like structure a proportion of the heat radiation from the heating plate 4 can travel directly through the plates 6A, 8A, reducing the convective effect. This is particularly useful when the appliance is used in a high power mode. By selecting the openness of the mesh, the amount of direct radiation can be controlled.

A third embodiment is illustrated in FIG. 7. This embodiment is similar to the first and second embodiments aside from the arrangement of corrugated metal plates. In this version a continuous metal sheet is used as the rear sheet 6B as in the first embodiment, whilst the front sheet 8B is of a mesh-like construction as in the second embodiment. Use of the mesh-like structure as the front plate increases the radiation directly reaching the stone member 10, reducing the convective effect. To the rear however the continuous metal plate 8B gives a greater convective effect as compared to a mesh-like structure, whereby the radiative heat reaching to the rear reflective plate 20 and rear housing 12 is reduced, thereby reducing the trapped heat and hence the temperature of the appliance.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A heating appliance for providing space heating comprising:
an electrical heating plate;
a first corrugated metal plate disposed adjacent the electrical heating plate with said corrugations arranged substantially vertically; and
a stone member disposed adjacent said corrugated metal plate.

2. The heating appliance of claim 1 wherein an additional metal plate is disposed on the opposite side of said electrical heating plate.

3. The heating appliance of claim 2 wherein the additional metal plate is also corrugated with said corrugations arranged substantially vertically.

4. The heating appliance of claim 2 wherein the electrical heating plate comprises an electrical resistance heating element supported on or forming part of a plate of heat resistant material.

5. The heating appliance of claim 4 wherein the plate of heat resistant material is formed of mica.

6. The heating appliance of claim 2 wherein the first corrugated metal plate is of shorter dimension in the vertical direction than the stone member and is disposed towards an upper region of the stone member, whereby at a lower region the electrical heating plate directly faces the stone member.

7. The heating appliance of claim 6 wherein the first corrugated metal plate extends about two-thirds of the way down the stone member whereby the stone member is directly exposed to the heating plate at the lower third thereof.

8. The heating appliance of claim 4 further comprising a rear cover, with said first and second corrugated metal plates and heating plate sandwiched between the rear cover and stone member and supported thereon.

9. The heating appliance of claim 1 wherein the stone member is found of natural marble, granite or limestone.

10. The heating appliance of claim 1 wherein the first corrugated metal plate has a mesh-like structure.

11. The heating appliance of claim 1 wherein the first corrugated metal plate has a solid structure.

12. A heating appliance for space heating comprising:
an electrical heat supplying plate;
a pair of corrugated metal plates including a front plate disposed respectively on a front face of the heating plate, and a rear plate disposed on a rear face;
a stone slab disposed adjacent the front corrugated metal plate; and
a rear housing, with said corrugated metal plates and heating plate enclosed and supported between the rear cover and stone slab.

13. The heating appliance of claim 12 wherein the front plate has a mesh-like structure, and the rear plate has a solid structure.
